(19) United States
(12) Patent Application Publication
(10) Pub. No.: US 2022/0138655 A1
(43) Pub. Date: May 5, 2022

(54) SUPPLY CHAIN RESTLTENCY PLAN GENERATION BASED ON RISK AND CARBON FOOTPRINT UTILIZING MACHINE LEARNING

(71) Applicant: International Business Machines Corporation, Armonk, NY (US)

(72) Inventors: Andrew Kinai, Nairobi (KE); Fred Ochieng Otieno, Nairobi (KE); Smitkumar Narotambhai Marvaniya, Bangalore (IN); Kedar Kulkarni Kulkarni, Bangalore (IN); Shantanu R. Godbole, Bangalore (IN); Navin Twarakavi, Karnataka (IN); Komminist Weldemariam, Ottawa (CA)

(21) Appl. No.: 17/083,583

(22) Filed: Oct. 29, 2020

(51) Int. Cl. G06Q 10/06; G06Q 50/28; G06Q 10/04; G06Q 30/00; G06Q 10/10; G06N 20/00; G01W 1/00

(52) U.S. Cl. CPC G06Q 10/06375; G06Q 50/28; G06Q 10/04; G06Q 10/0635; G01W 1/00; G06Q 10/10; G06Q 10/06315; G06N 20/00; G06Q 30/018

(57) ABSTRACT

A supply chain optimization method, system, and computer program product include predicting a risk of a supply chain operation across a supply chain network caused by a term impact analysis of a global hazard, estimating a carbon footprint for the supply chain operation across the supply chain network, generating an alternative resilience plan as an alternative to an existing supply chain plan based on the predicted risk and the estimated carbon footprint.

### BACKGROUND

The present invention relates generally to a supply chain optimization method, and more particularly, but not by way of limitation, to a system, method, and computer program product for optimizing supply chain operations based on jointly analyzing climate risks and carbon footprints.

A disruptive event such as a flood, hurricane and most recently a COVID-19 global pandemic, has brought the resilience of supply chains into sharp focus.

A majority of companies are aware of climate-related hazards and they are often well-informed about their potential exposure. Even though most companies attempt to have alternate sourcing plans, most lack a fundamental understanding of their vulnerability to such climate hazards.

This vulnerability presents an opportunity to address various multi-tier supply chain risks through various platforms by sourcing critical components and fulfilling orders.

One exemplary technique has considered a mixed integer linear programming (MILP) model to obtain optimal decisions based on a carbon footprint by considering a partner selection, a technology selection, a transportation model selection, a material procurement, a product supply, and a recovery model.

Another exemplary technique has proposed to optimize order fulfilment by considering multiple supply modes such as a supply of inventory by forecasting demand, estimating accuracy of the forecasted demand, and establishing reorder point policy based on accuracy forecasted demand, supply transportation modes, cost of carbon emissions and a limit on carbon emission credits.

### SUMMARY

However, the conventional techniques do not jointly optimize supply chain operations based on a climatic risk and a carbon footprint while generating an alternative resiliency policy.

Thereby, the inventors have identified a need in the art and have discovered a novel technique using an interactive dashboard to enable resiliency detection in supply chain operations by jointly optimizing the climate risk and the carbon footprint. The invention also enables dynamic user interactions via a Graphical User Interface (GUI) with the considerations while generating policies for the supply chain using Gaussian Process Regression (GPR) and Reinforcement Learning (RL).

That is, the invention includes a practical application as a result of a technical improvement because the invention can generate alternative resilience plans based on predicted risk and estimated carbon footprints, using trained deep reinforcement learning, multi-objective optimization function while displaying the results in a new, inventive Graphical User Interface (GUI) for easy end-user operability and analysis (i.e., a practical application of the deep analytics).

In one exemplary embodiment, the present invention provides a computer-implemented supply chain optimization method, the method includes predicting a risk of a supply chain operation across a supply chain network caused by a term impact analysis of a global hazard, estimating a carbon footprint for the supply chain operation across the supply chain network, generating an alternative resilience plan as an alternative to an existing supply chain plan based on the predicted risk and the estimated carbon footprint.

Other details and embodiments of the invention are described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a supply chain optimization method 100 according to an embodiment of the present invention;

FIG. 2 exemplarily shows a global t-shirt supply chain;

FIG. 3 exemplarily depicts a system diagram for resiliency policy generation;

FIG. 4 exemplarily depicts a detailed view of steps of the system diagram;

FIG. 5 exemplarily depicts interactive portions of an interactive dashboard of a Graphical User Interface (GUI) 600;

FIGS. 6A-13 exemplarily depict the interactive dashboard of the GUI 600 for a biscuit supply chain optimization;

FIG. 14 depicts a cloud-computing node 10 according to an embodiment of the present invention;

FIG. 15 depicts a cloud-computing environment 50 according to an embodiment of the present invention; and

FIG. 16 depicts abstraction model layers according to an embodiment of the present invention.

### DETAILED DESCRIPTION

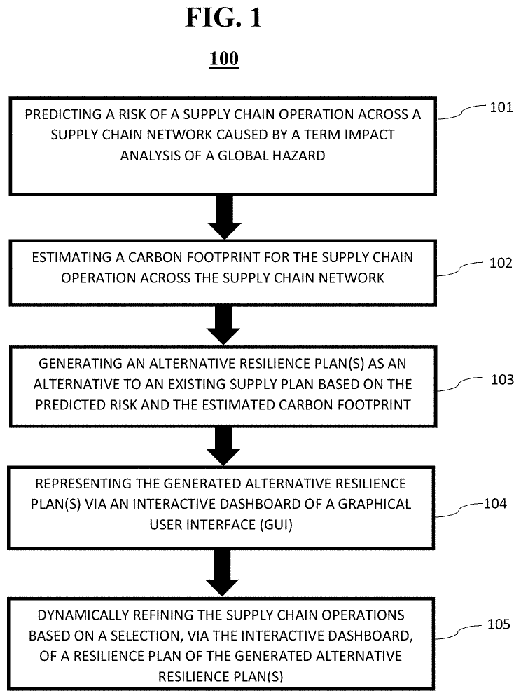

The invention will now be described with reference to FIGS. 1-16, in which like reference numerals refer to like parts throughout. It is emphasized that, according to common practice, the various features of the drawings are not necessarily to scale. On the contrary, the dimensions of the various features can be arbitrarily expanded or reduced for clarity.

By way of introduction of the example depicted in FIG. 1, an embodiment of a supply chain optimization method 100 according to the present invention can include various steps for a novel technique for enabling resiliency in a supply chain by jointly optimizing supply chain operations based on joint analysis of climate risk and carbon footprint.

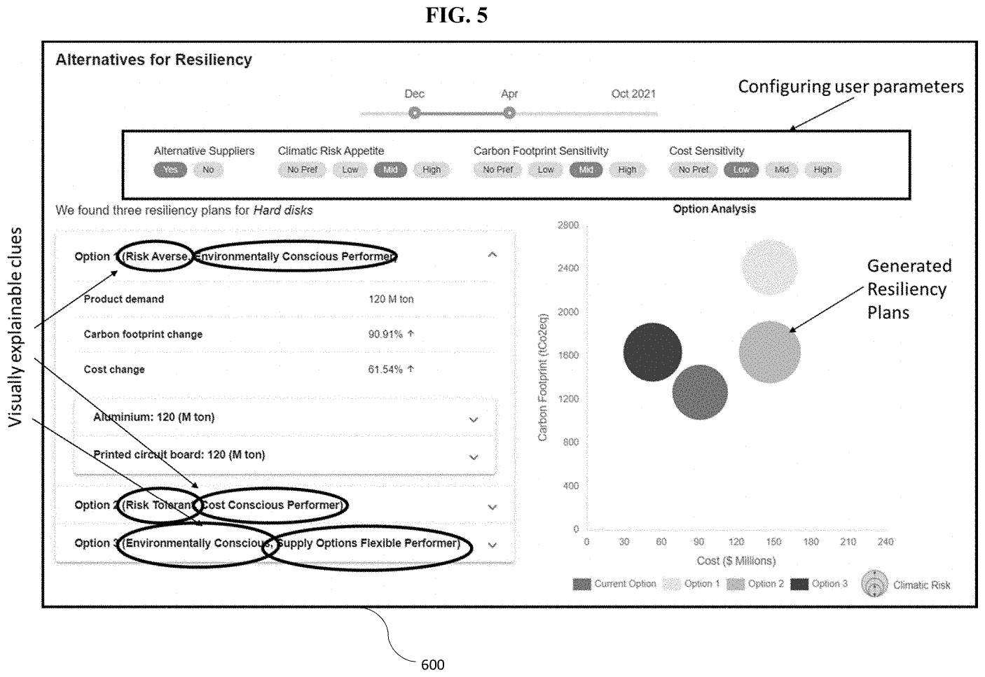

Indeed, the method 100 includes steps for estimating/predicting a risk of supply chain operations across supply chain network (various nodes and edges) due to medium-to-long term impact analysis of climate predictions and extreme events (i.e., ‘global hazards’ as used in the claims), estimating carbon footprints for the operations across supply chain network (various nodes and edges), generating alternative resilience plans based on predicted risk and estimated carbon footprints, using trained deep reinforcement learning, multi-objective optimization function, GPR, etc., representing the generated alternative resilience plans on what-if via novel interactive dashboard, and dynamically refining/optimizing supply chain operations based on user-selected resilience plan (multi-objective optimization functions). The steps enable the auto-discovery of a set of initial version of resiliency plans at every stage (e.g., at nodes and edges) in the supply chain, where each resiliency plan has an estimated cost associated therewith. The method 100 can automatically generate visually explainable clues (i.e., as shown in FIG. 5) for each resiliency plan for the user to evaluate based on user-selected parameters. And, the method 100 can include configuring user parameters, including alternative supplier on/oft; climate risk level preference: low, mid, high, carbon footprint sensitivity, cost sensitivity, etc.

It is noted that ‘climate risk’ and ‘extreme events’ (i.e., global hazards) are interchangeably used in illustrations but can replace each other in the descriptions provided herein or be considered additively to each other.

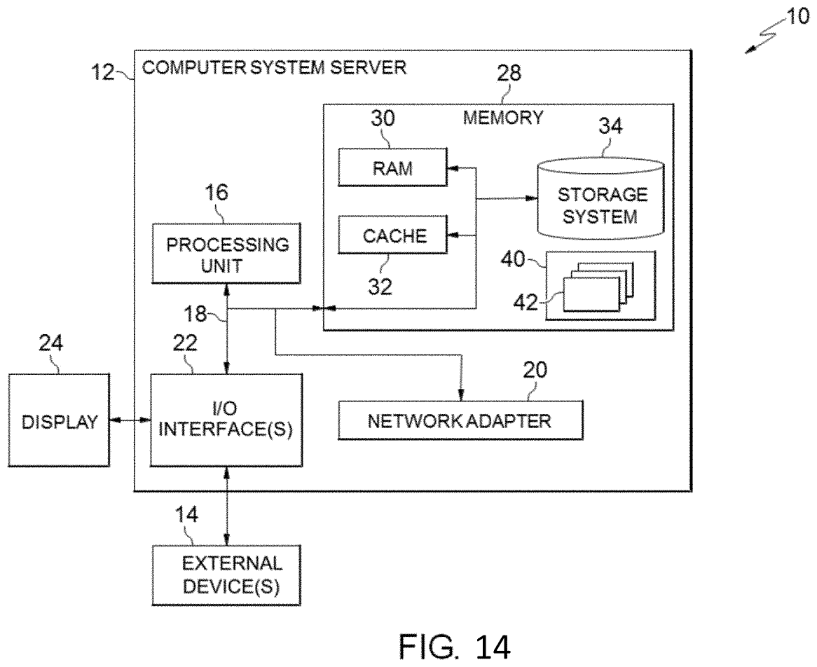

By way of introduction of the example depicted in FIG. 14, one or more computers of a computer system 12 according to an embodiment of the present invention can include a memory 28 having instructions stored in a storage system to perform the steps of FIG. 1.

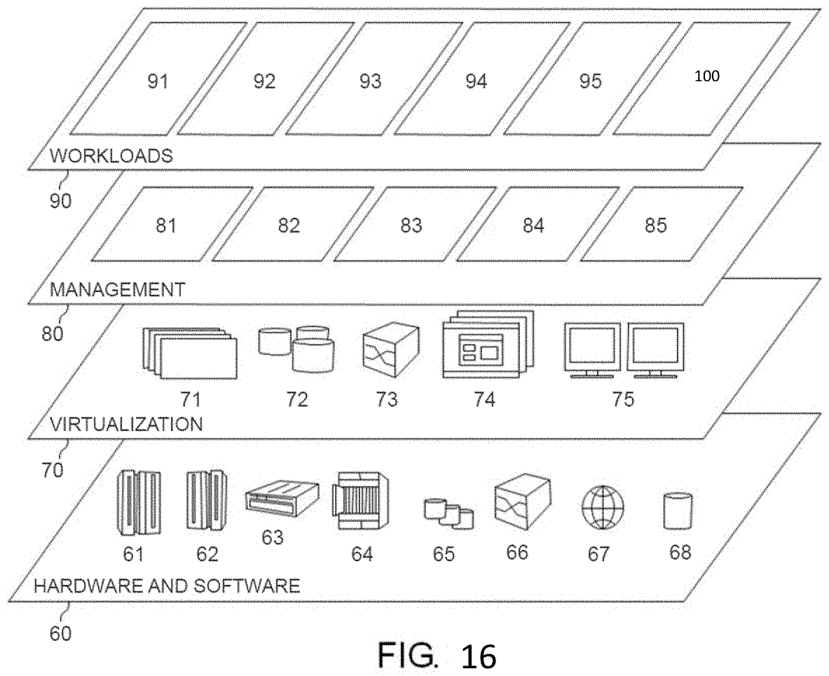

Although one or more embodiments may be implemented in a cloud environment 50 (e.g., FIG. 16), it is nonetheless understood that the present invention can be implemented outside of the cloud environment.

With reference generally to FIGS. 1-4, in step 101 of method 100, the invention predicts a risk of a supply chain operation across a supply chain network caused by a term impact analysis of a global hazard (i.e., the global hazards).

In step 102, a carbon footprint for the supply chain operation is estimated across the supply chain network.

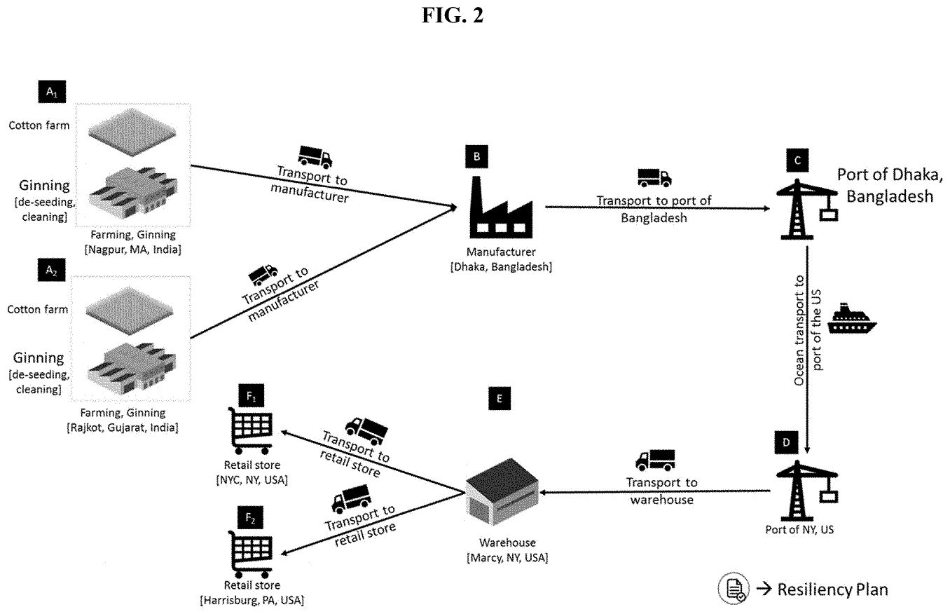

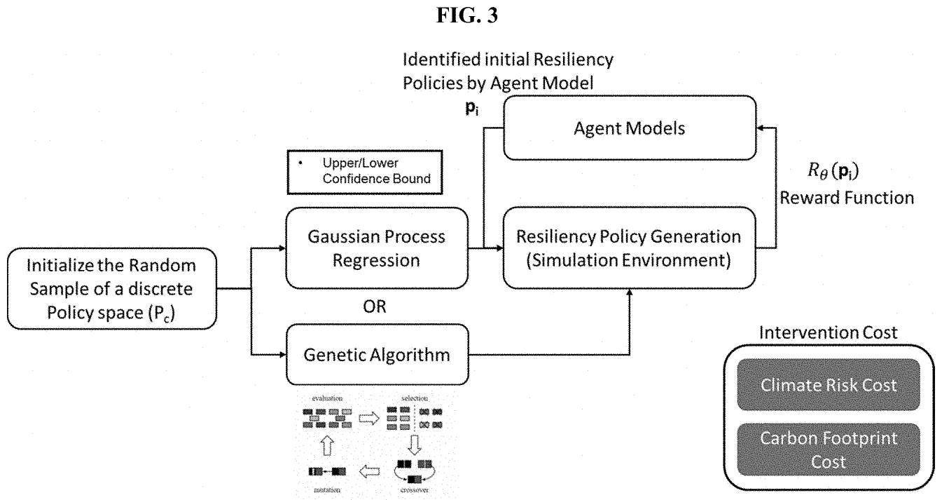

FIG. 2 exemplarily depicts a global t-shirt supply chain. At a high level, steps 101 and 102 analyze the supply chain as shown in FIG. 2 to predict the risk of the supply chain by considering, for example, climate predictions and extreme event predictions.

For example, the material for the t-shirts are supplied from a cotton farm in India to a manufacturer in Bangladesh. However, drought can affect the supply of the cotton from the farm. Also, monsoons, global pandemics, etc. are considered as extreme event predictions which can change how the cotton is transported from the farm to the manufacturer. Or, the events can change the supply from the farm (i.e., cotton cannot grow in a drought potentially).

Also, the carbon footprint of the supply chain is considered. For example, an alternative farm in Bangladesh may cause an increase in cost for the cotton, but the carbon footprint for the supply chain would be lower since there is less distance to transport the raw materials.

Thus, the invention via steps 101-102 models the supply chain and then analyzes all of the factors (i.e., climate prediction and extreme event prediction as well as the carbon footprint) for each node in the supply chain. That is, the invention includes an artificial intelligence-based estimating of various climatic risks such as flood, drought, water availability, infrastructure risk, heatwave, cold-wave over a period of time to accurately estimate the supply chain risks such as production risk, supplier risk, supplier selection, resilient procurement, etc.

Also, the invention includes estimating various carbon footprint costs based on the supply chain activities including supplier selection, transportation, manufacturing operations, etc.

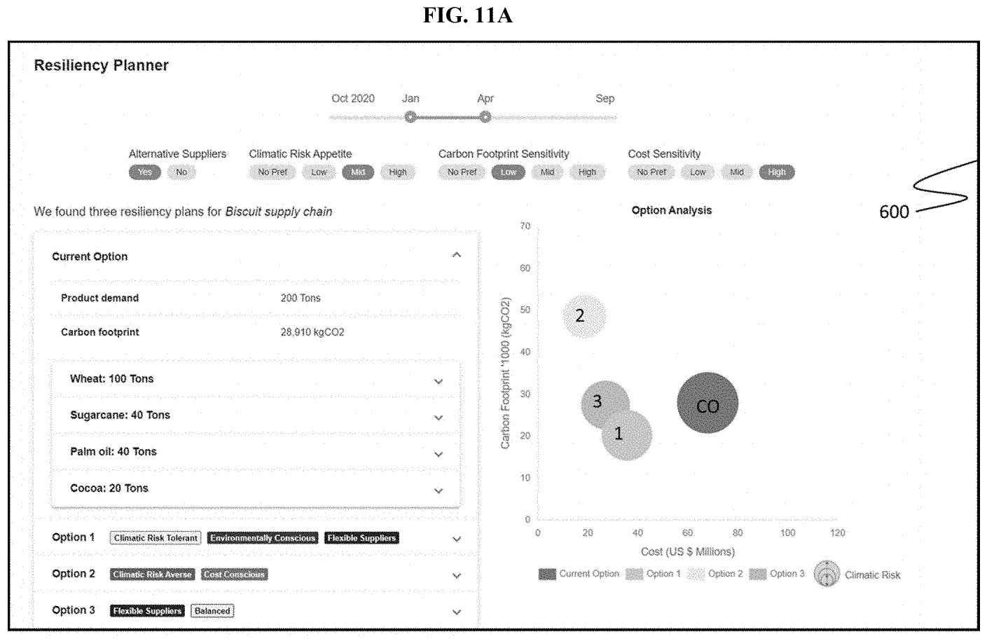

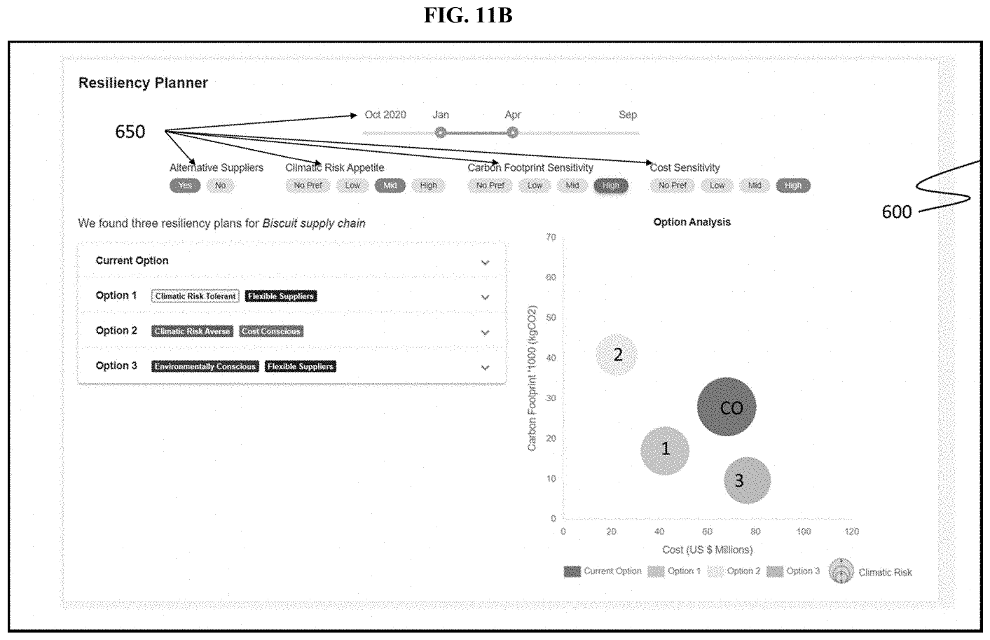

In step 103, alternative resilience plans (i.e., ‘option 1’, ‘option 2’, ‘option 3’ as depicted in FIG. 11A) are generated as an alternative to an existing supply chain plan based on the predicted risk and the estimated carbon footprint for each option respectively.

The alternative resilience plans may be generated based on a trained deep reinforcement learning, a multi-objective optimization function; and a Gaussian Process Regression (GPR).

For example, the Gaussian process regression (GPR) is a nonparametric, supervised learning technique, in which the stochastic scalar rewards R, are used to train a Gaussian Process to infer with confidence bounds the performance of actions across the resiliency policy space. GPR is Bayesian approach to regression and it has several benefits, working well on small datasets and having the ability to provide uncertainty measurements on the prediction. The learnt parameters describe the posterior distribution over R(a) to train a Gaussian Process to infer with confidence bounds the performance of actions across the resiliency policy space.

In one exemplarily embodiment, one of the alternative resilience plans can include using a different cotton farm as an alternative supplier to reduce the carbon footprint. In another embodiment, a percentage of a required amount of cotton received from each current supplier can be changed to reduce risk. Also, a different farm has lower risk for drought because of a different climate. Therefore, the plan is shown (as discussed later) with an improved carbon footprint and a decreased risk but has a higher cost associated with these changes (i.e., the alternative resilience plan is shown based on multiple dimensions of cost, environment, and risk). For example, if 100 tons of cotton is required for manufacturing, the alternative resiliency plan can change an allocation of 30% of the total from one farm to 60% of the total from the same farm to decrease the carbon footprint.

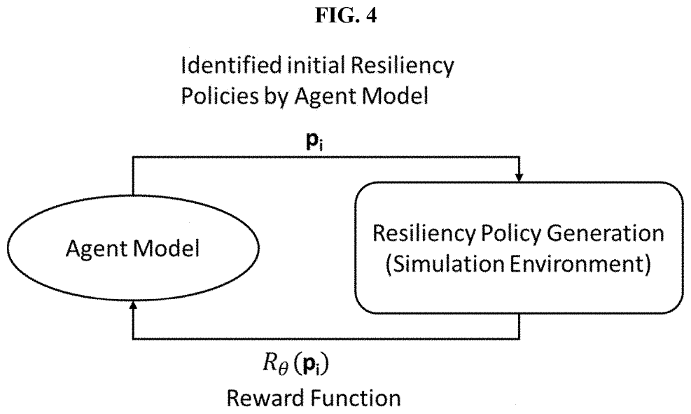

With reference to FIGS. 3-4, FIGS. 3-4 depict a process flow of the resiliency policy generation using reinforcement learning (RL) and Gaussian Process Regression (GPR). To generate the policy, a random sample of discrete policy space (P_{c}) is initialized. The GPR is a supervised learning technique, in which stochastic scalar rewards R, are used to train a Gaussian Process to infer with confidence bounds (“upper and lower confidence bound”) the performance of actions across the policy space (P_{c}). A set of stochastic rewards R(p¹), . . . , R(pⁿ) along with mean and covariance are estimated after each simulated policy. For the upper and lower confidence bound, this formulation helps in combining the natural confidence bounds of Gaussian Processes for stochastic multi-armed bandit problems.

Each agent model performs sequential batch exploration, towards optimisation of an unknown stochastic reward function R. That is, a set of policies are chosen as a part of each batch. A reward function (R(pᵢ)) is used to find solutions of maximal reward in as few batches i as possible. The goal being to approximate p*=argmax_{p∈P} R(p).

The reward associated with each policy R_{θ}(pᵢ) is stochastic through the parameterisation of the simulation θ which generates a randomized distribution of parameters for the Resiliency Policy Generation Simulation. The magnitude of the reward is determined through cost-effectiveness analysis of the stochastic simulation output.

Also, intervention cost may be considered. In this invention, the intervention cost is defined as a climate risk cost and a carbon footprint cost. The cost of the intervention (Cᵢₙₜ) is the sum of a climate risk cost and a carbon footprint cost for a given time window.

The invention generates the resiliency policies by initializing random sample of discrete policies (P_{c}), using multiple agent models to generate various resiliency policies in multiple batches by simulating the environment, and using approximation methods via reward function estimation to find solutions of maximal reward in a few batches. Then, a Gaussian Process Regression or a Genetic Algorithm based method is used to compute the most optimal resiliency policy(ies) that satisfy carbon footprint, climate risk and dynamic user interactions. The invention computes the intervention (Cᵢₙₜ) that captures the climate risk cost, carbon footprint cost and constraints based on dynamic user interactions for each of the resiliency policies.

It is noted that, in the invention, a Genetic Algorithm can be used as an ‘black box’ optimisation technique for the exploration of the resiliency policy space. The Genetic optimizer evaluates the population by measuring a fitness function for the auto-generated resiliency policy. Given an evaluated population, in this case a set of resiliency policies and their stochastic rewards, the GA with then discovering the next generation of the population. Genetic Algorithm allows parallel search from a population of points and computationally efficient and able to avoid being trapped in local optimal solution.

In sum, the invention creates a simulation environment from which an agent learns the most effective resiliency policies for supply chain that captures the most cost-effective intervention strategies in the context of climate risk, carbon footprint, and user interactions. The invention uses multiple agents to determine the optimal supply chain resiliency based on the any combination of climate risk, carbon footprint, and user interactions preferences.

In sum, the invention creates a simulation environment from which an agent learns the most effective resiliency policies for supply chain that captures the most cost-effective intervention strategies in the context of climate risk, carbon footprint, and user interactions. The invention uses multiple agents to determine the optimal supply chain resiliency based on the any combination of climate risk, carbon footprint, and user interactions preferences.

In the case of an exemplary biscuit supply chain, as discussed in detail below, there are multiple different stages in the biscuit supply chain such as raw material source, manufacturing, storage and retail.

To manufacture biscuit, one needs multiple different raw materials such as wheat, sugarcane, palm oil, Cocoa, etc. The qualities of these raw materials will be depending on the recipe of the biscuit and the demand quantity of the biscuit. One needs 0.5 tons of wheat, 0.2 tons of sugarcane, 0.2 tons of palm oil, and 0.1 tons of cocoa to prepare 1 tone of biscuit. There are many combinations of raw materials sources. The invention performs a search exploration for discovering the resiliency policy that satisfies the constraints related to carbon footprint, climatic risk and the user interactions via interaction cost. Gaussian process regressor is used to evaluate the reward for the auto discovered resiliency policies.

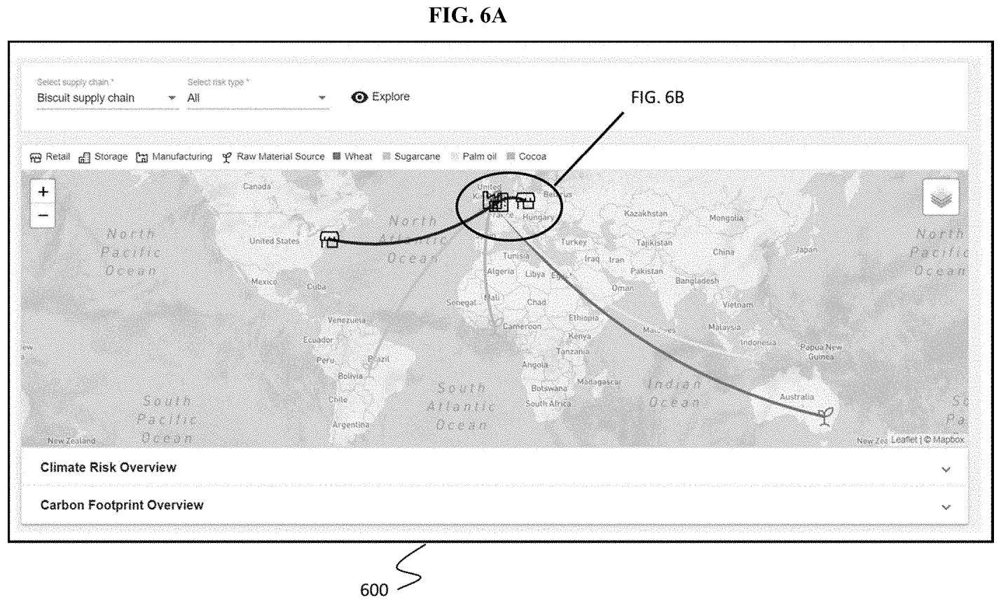

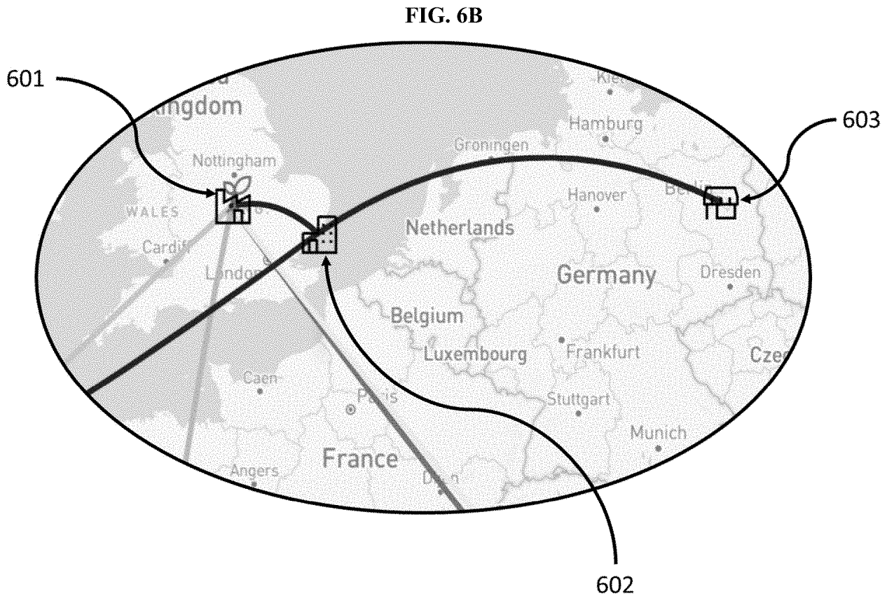

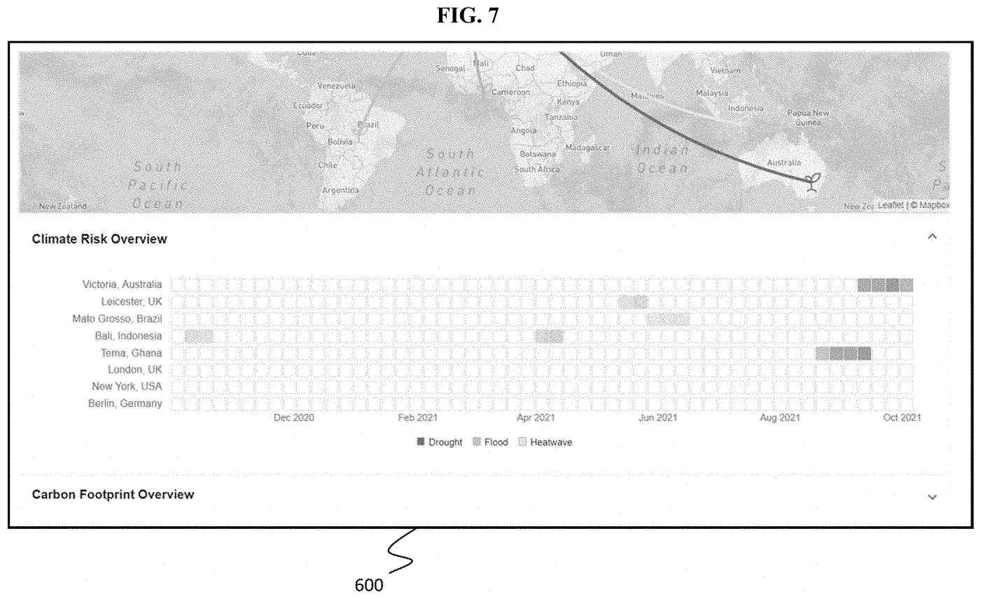

In step 104, the generated alternative resilience plan(s) are represented via an interactive dashboard of a Graphical User Interface (GUI) 600. One example of the dashboard is shown in FIGS. 6A-6B which depicts an existing supply chain plan.

Although a plurality of plans being generated is described herein, the invention can operate by generating one alternative resiliency plan to compare with the current plan.

In step 105, the supply chain operations are dynamically refined based on a selection, via the interactive dashboard, of a resilience plan of the generated alternative resilience plans. As shown in FIG. 5, user parameters can be selected to change levels of risk associated with climate, carbon footprint, and cost as well as alternative suppliers can be selected (i.e., if it is acceptable to use different suppliers). The resiliency plans are graphically depicted as shown in FIG. 5 where the climate risk is shown by the radius of the circles (i.e., the larger the radius, the larger the climate risk) as well as the carbon footprint and cost by the location of the center of the circle on the X and Y axis.

That is, the invention jointly optimizes the resiliency policy that captures climate risk, carbon footprint, and dynamic user interactions. To do this, the invention auto-discovers the initial version of resiliency policies at every stage in the supply chain (i.e., the current supply chain plan). A set of resiliency plans are generated by estimating the cost associated with each possible resiliency plan.

Indeed, the invention displays each option alongside the current plan as a function of climate risk, carbon footprint, and cost. The options are displayed with visually explainable clues to summarize the options (i.e., as shown in FIG. 5).

For example, as shown in FIG. 5, ‘Option 1’ includes a risk averse and environmentally conscious plan as compared to ‘Option 3’ which is environmentally conscious and supply option flexible. As ‘Option 1’ includes “risk averse”, it costs more than ‘Option 3’ to attain the risk averse aspect (i.e., about 120 million dollars more). The cost associated with a resiliency plan could include a replenishment planning strategy at a distribution level, additional cost associated with change in the inventory, logistic cost, supplier selection, overall carbon footprint reduction, etc. Changing a supplier to a different location has different costs and results in different risks and different carbon footprint.

For example, moving a supplier of cotton from India to Florida when the manufacturing plant is in Bangladesh might reduce climate risk (i.e., drought, hurricanes, etc.) but increase carbon footprint because the distance that would be required to travel to deliver the cotton from Florida to Bangladesh is greater than that from India to Bangladesh (i.e., greater carbon footprint). But, one company may with to eliminate all climate risk with their supply chain and are willing to have a greater carbon footprint and spend more money on shipping. The visualization shows these options alongside the initial plan in a practical manner that is easy for an end user to decipher which plan to select.

It is also noted that the parameters are over a specified time frame. That is, as shown in FIGS. 5 and 11B, a slider 650 is included in the GUI to adjust a time frame for optimizing the supply chain network. In this manner, the user can look at a specified time window that they want to change the supply chain operations.

Moreover, the invention includes an additional feature for enabling the continuous improvement in the auto-discovered resiliency policies by learning the reward function while training deep reinforcement learning models, and solving a multi-objective optimization that captures overall cost, carbon footprint, climatic risk, and dynamic user interactions. Thereby, the invention can improve over time via machine learning.

With reference now to FIGS. 6A-13, operation of the interactive dashboard of the GUI 600 is depicted for an exemplary biscuit supply chain.

As shown in FIG. 6A, the biscuit supply chain includes retail of the biscuits, storage of the biscuits, manufacturing of the biscuits, and a location of the raw source materials (i.e., wheat, sugarcane, palm oil, and cocoa) that are purchased to manufacture the biscuits. The GUI 600 shows all of these elements pictorially on a map with a climate risk overview click-down element and a carbon footprint overview click-down element. FIG. 6B is an enlarged portion of the map showing the manufacturing; storage, and retail of the biscuits in Europe.

As shown in FIGS. 6A-6B, a manufacturing plant 601 for biscuits in New Hampshire, UK that receives wheat from Victoria, Australia and Leicester, UK with an alternate supplier from Sehore, India, receives sugarcane from Mato Grosso, Brazil with an alternative supplier from Florida, USA, receives palm oil from Bali, Indonesia, and Cocoa from Tema, Ghana. Once manufactured, the manufactured biscuits are stored at a storage facility 602 (Felixstowe distribution and shipyard centre, UK). From the storage facility 602, the biscuits are shipped for retail to Berlin, Germany 603 and New York, USA.

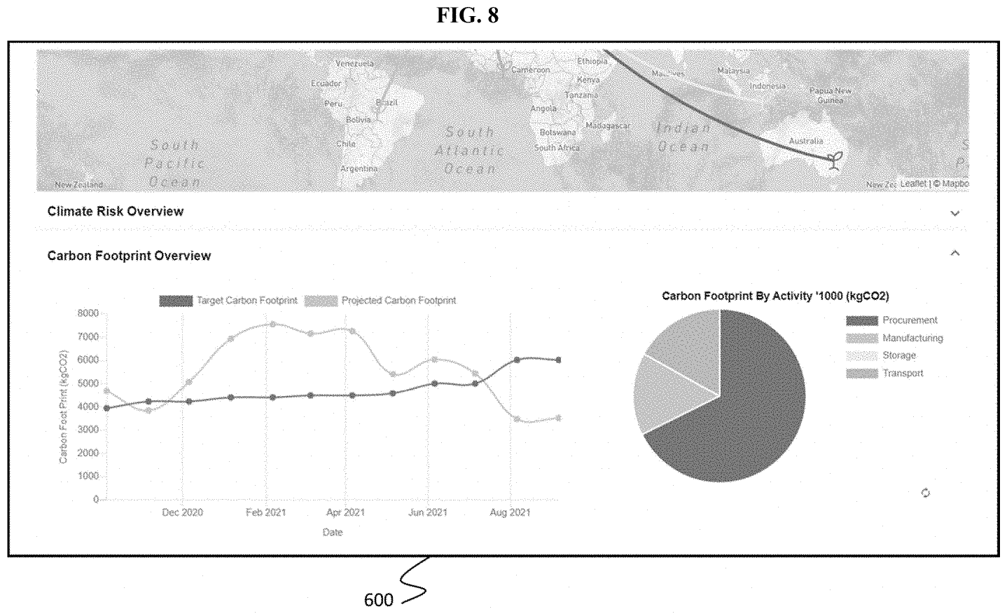

The supply chain shown in FIGS. 6A-6B is the ‘existing supply chain plan’ that is automatically discovered as a set of initial versions of resiliency plans at every stage (nodes and edges) in the supply chain, wherein each resiliency plan has an estimated cost associated therewith. FIGS. 7-8 depict the climate risk overview and the carbon footprint for each node in the existing supply chain plan.

For example, if the time frame was adjusted via the slider on the GUI to include a time frame such as October 2021, Victoria, AU would have a severe drought risk. Accordingly, as discussed later, alternate suppliers would have lower climate risk.

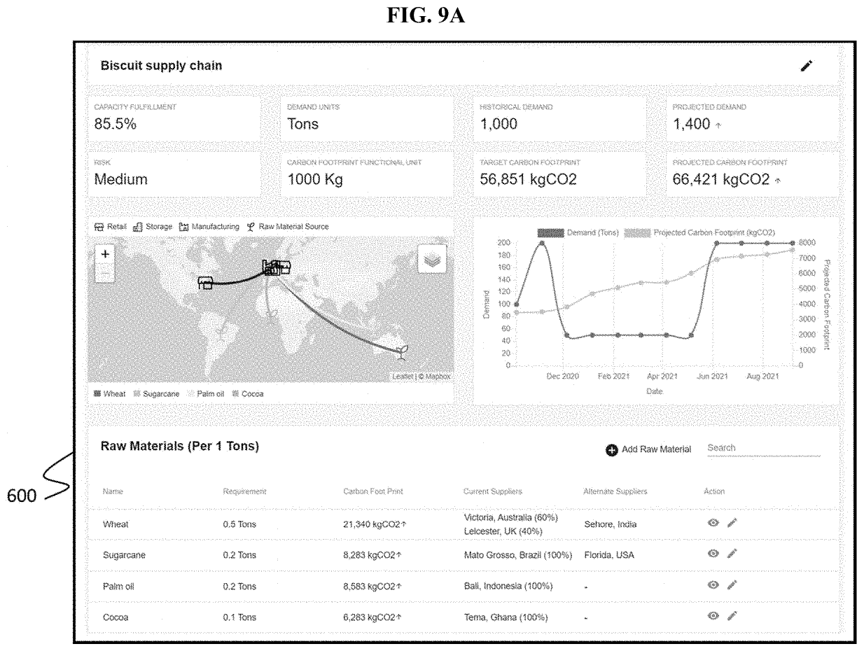

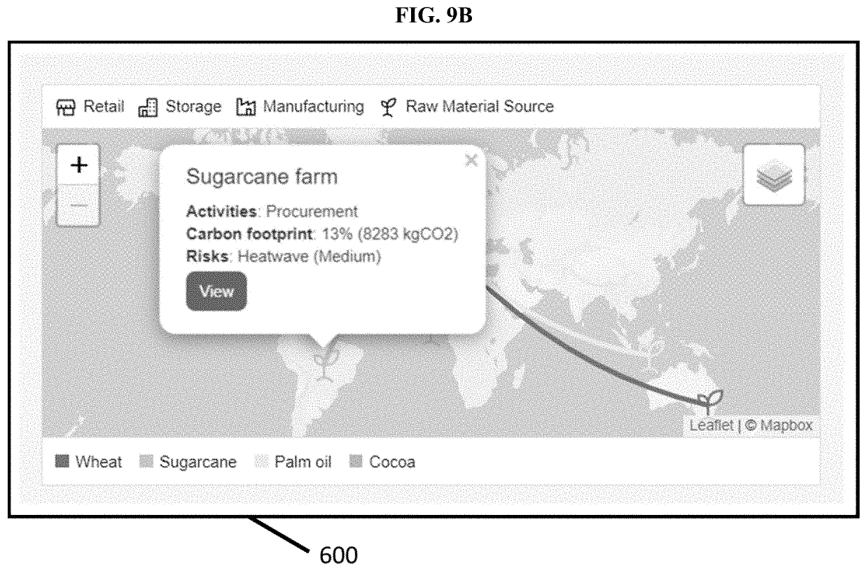

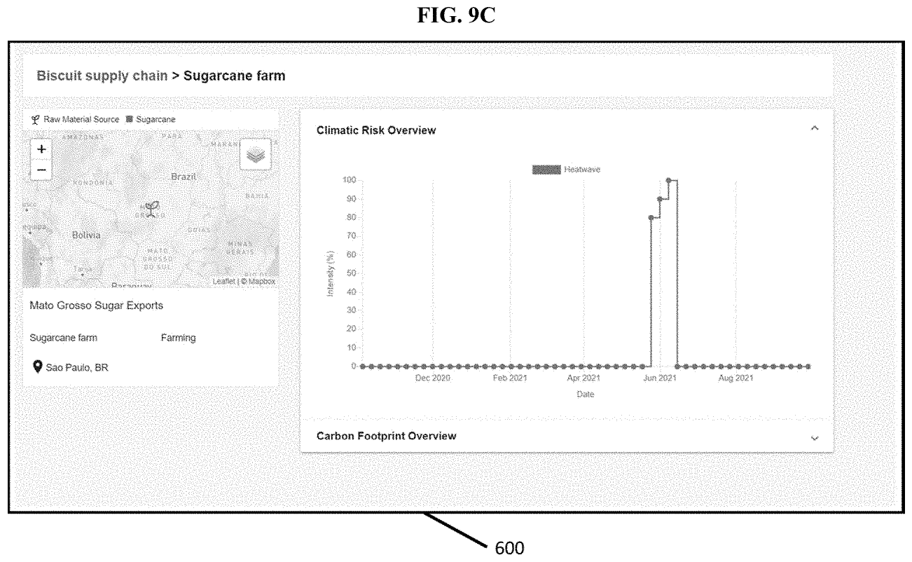

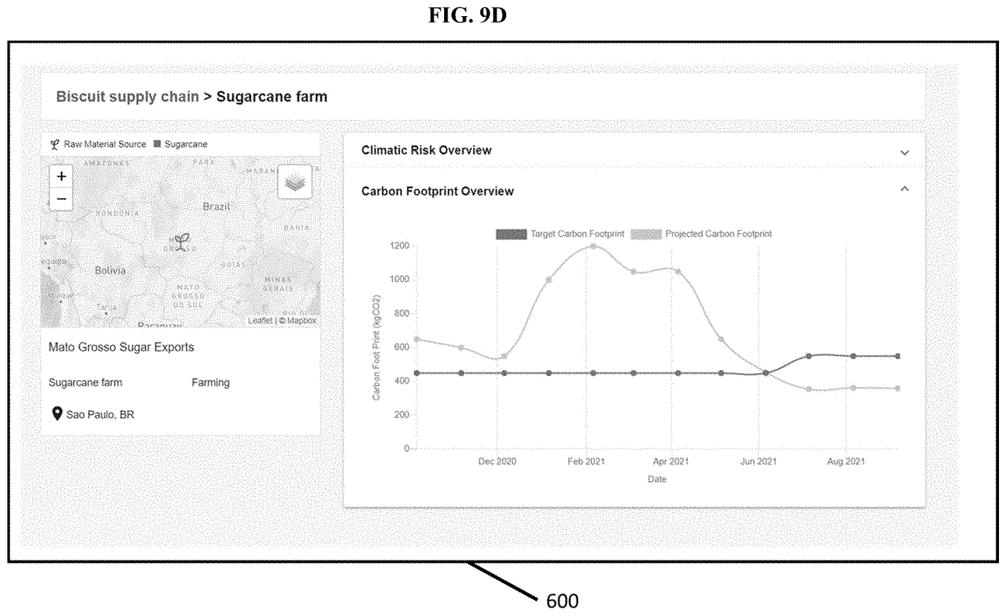

FIGS. 9A-9D depict a detailed description of each node within the supply chain as well as all data that is considered when generating alternate resiliency plans. For example, FIG. 9A shows the existing supply chain plan as well as alternate suppliers and the requirements of each of the suppliers. FIG. 9B depicts an interactive feature of the GUI 600 by showing an interaction (i.e., ‘clicking’) with the sugarcane farm which shows details of this part of the supply chain. FIGS. 9C-9D shows the screen 600 after ‘clicking’ on the ‘view’ interactive element which shows the climate risk overview and carbon footprint for the sugarcane farm of Sao Paulo, BR.

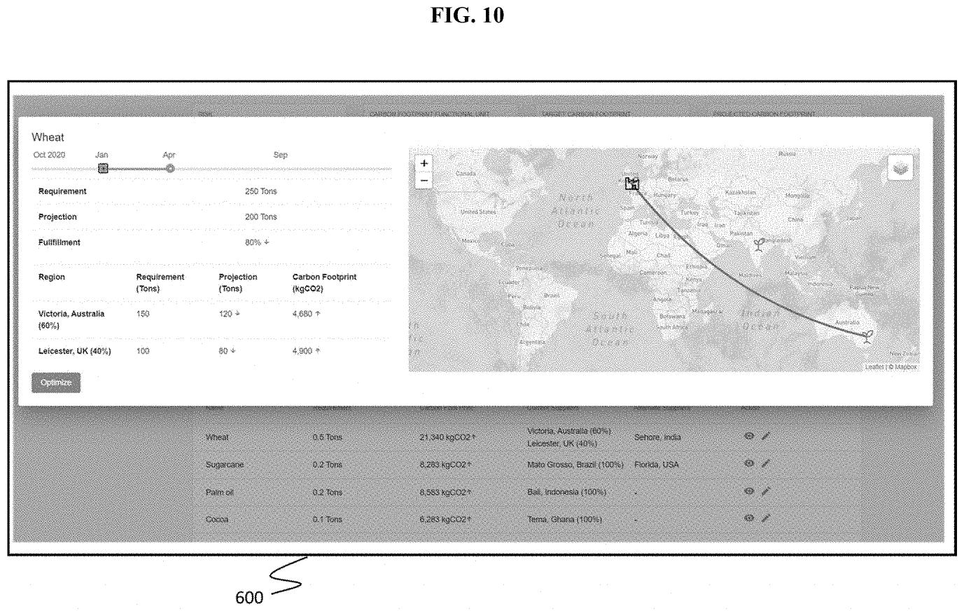

With reference back to FIG. 9A, each of the materials can be ‘optimized’ thereby providing an alternate resiliency plan. FIG. 10 depicts the screen 600 when the materials in the supply chain are selected to be optimized. FIG. 10 shows the current parameters of the ‘existing supply chain plan’ and clicking the ‘optimize’ interactive element runs the background computation as described in method 100 and shown in FIGS. 3-4 to generate the alternate resiliency plans.

Having clicked the ‘optimize’ interactive element, FIG. 11A is the next screen in the GUI 600 that provides an output from steps 103-104. That is, the alternate resiliency plans are generated and represented via the interactive dashboard of the GUI 600. In this example, three options (1, 2, 3) and the current option (i.e., ‘existing supply chain plan’) are shown. FIG. 11B shows the interactive element 650 of the GUI 600 by changing preferences such as using alternative suppliers, climate risk, carbon footprint, and/or cost.

As can be seen in the different outputs between FIG. 11A and FIG. 11B, the carbon footprint sensitivity is increased from ‘low’ in FIG. 11A to ‘high’ in FIG. 11B. Most noticeably, ‘option 3’ changes from costing about 30 million dollars to 80 million dollars in order to decrease the carbon footprint amount by about 20 on the scale. That is, the GUI is interactive with the sliders 650 to quickly show the changes in the alternative resiliency plans based on different tolerances of risk and cost.

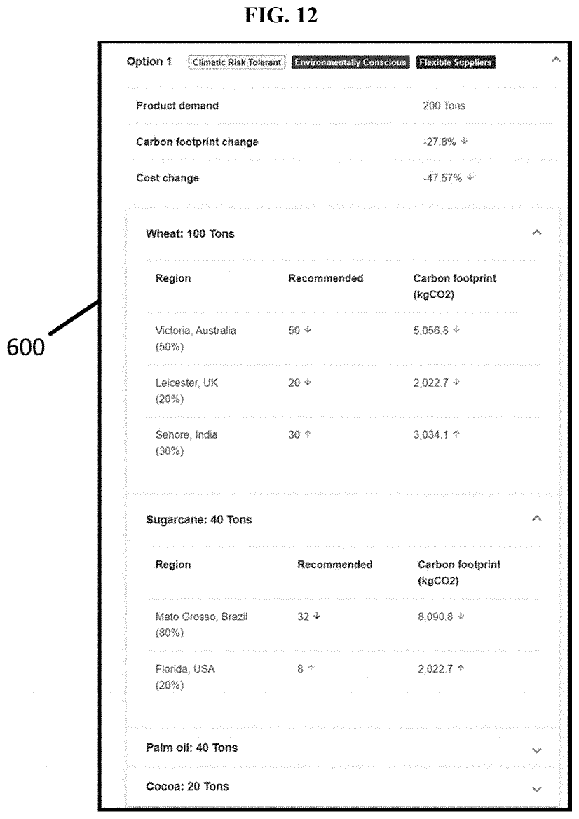

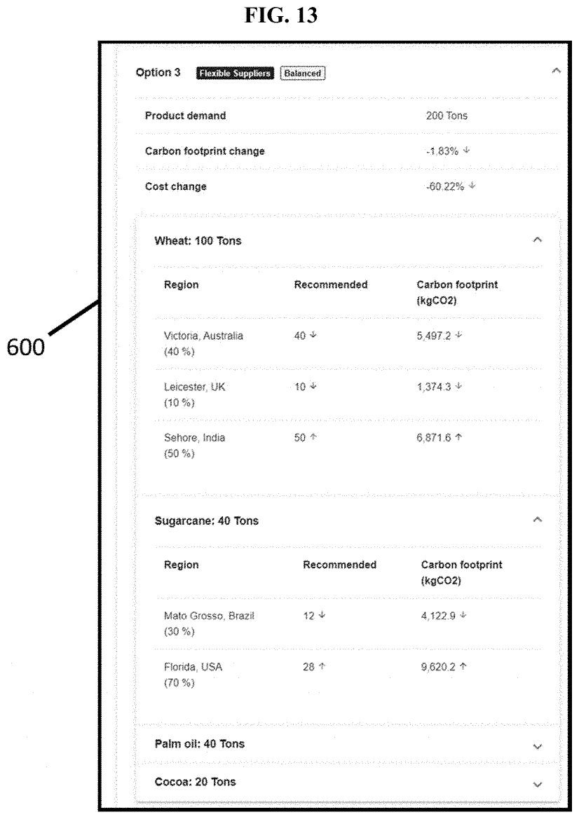

FIGS. 12-13 exemplarily depict ‘option 1’ and ‘option 3’ as two alternative resiliency plans for the selections in FIG. 11A. In ‘option 1’ a climate risk tolerant, environmentally conscious with flexible suppliers plan is provided as the output. In this option, it is recommended to add an additional supplier of wheat from Sehore, India and reduce the supply from the current suppliers. The changes are similarly suggested for the other raw materials. In doing so, the cost is reduced by 47.57% and carbon footprint is reduced by 26.8%.

‘Option 3’ is shown in FIG. 13 as a supply chain plan with flexible suppliers and balances cost, carbon footprint, and risk. As shown, in ‘option 3’, the alternative supplier from Sehore, India for wheat is also recommended. But, the recommendation has 50% of the supply coming from this supplier instead of the 30% of ‘option 1’. Similar recommendation are detailed in each raw material which can be interacted with via the click down buttons. ‘Option 3’ provides a 2% carbon footprint change but a 60% reduction in cost.

These options are visually shown in FIG. 11A in a manner that a user can easily interact with the GUI 600 to determine which option is best for their company.

The invention provides the practical application of an easy to use GUI 600 using the background complex computations of steps 103-104 of the method 100. That is, the invention provides a dynamically adjustable output for a user to interact with and change their concerns about a supply chain. The invention auto-discovers the alternate resilience plans by generating various what-if scenarios via an interactive dashboard.

Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 14, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring now to FIG. 14, a computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further described below, memory 28 may include a computer program product storing one or program modules 42 comprising computer readable instructions configured to carry out one or more features of the present invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may be adapted for implementation in a networking environment. In some embodiments, program modules 42 are adapted to generally carry out one or more functions and/or methodologies of the present invention.

Computer system/server 12 may also communicate with one or more external devices 14 such as a keyboard, a pointing circuit, other peripherals, such as display 24, etc., and one or more components that facilitate interaction with computer system/server 12. Such communication can occur via Input/Output (I/O) interface 22, and/or any circuits (e.g., network card, modem, etc.) that enable computer system/server 12 to communicate with one or more other computing circuits. For example, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

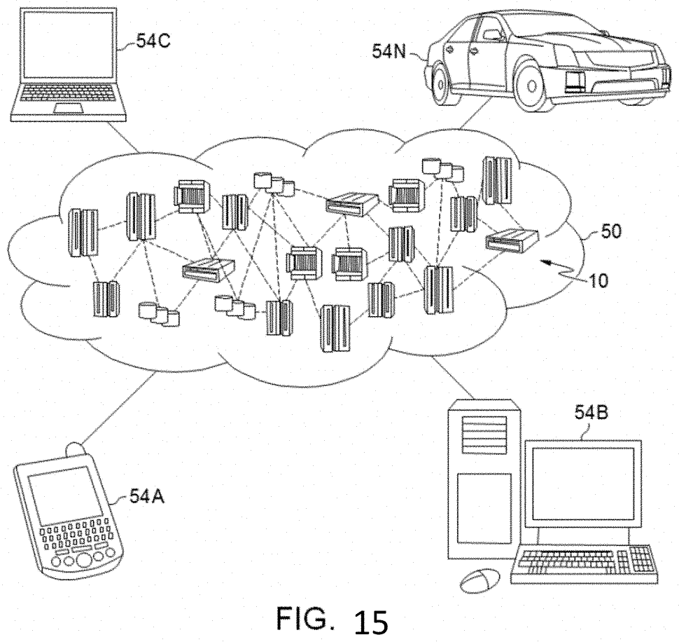

Referring now to FIG. 15, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 15 are intended to be illustrative only and that computing nodes 10 and cloud computing environment 50 can communicate with any type of computerized circuit over any type of network and/or network addressable connection (e.g., using a web browser).

Referring now to FIG. 16, an exemplary set of functional abstraction layers provided by cloud computing environment 50 (FIG. 15) is shown. It should be understood in advance that the components, layers, and functions shown in FIG. 16 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and supply chain optimization method 100 in accordance with the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

1. A computer-implemented supply chain optimization method, the method comprising:
predicting a risk of a plurality of supply chain operations that are used in a supply chain network caused by a term impact analysis of a global hazard;
estimating a carbon footprint for the supply chain network caused by transporting a product between the plurality of the supply chain operations in the supply chain network;
generating an alternative resilience plan as an alternative to an existing supply chain plan based on the predicted risk and the estimated carbon footprint in order to achieve an objective by varying which of the plurality of supply chain operations are used within the supply chain network;
representing the generated alternative resilience plan via an interactive dashboard of a Graphical User Interface (GUI); and
learning a continuous improvement in an auto-discovered resiliency plan as the existing supply chain plan by learning a reward function while training deep reinforcement learning models and solving multi-objective optimization that captures an overall cost, a carbon footprint, a climatic risk, and dynamic user interactions with the GUI,
wherein the generating obtains the objective by creating a simulation environment from which an agent learns a most effective resilience plan for the supply chain network that captures a most cost-effective intervention strategies in a context of the climate risk, the overall cost, and the carbon footprint.

2. The computer-implemented method of claim 1, further comprising:
generating a plurality of alternative resilience plans.

3. The computer-implemented method of claim 2, further comprising dynamically refining a supply chain operation used within the supply chain network based on a selection, via the interactive dashboard, of a resilience plan of the generated alternative resilience plans.

4. The computer-implemented method of claim 1, wherein the alternative resilience plan is generated using at least one of:
a trained deep reinforcement learning;
a multi-objective optimization function; and
a Gaussian Process Regression (GPR).

5. The computer-implemented method of claim 2, wherein the interactive dashboard includes a selection panel including:
a selection to adjust an importance factor for a consideration of risk, a consideration of the carbon footprint, and a consideration of cost; and
a selection to add an alternate supplier.

6. The computer-implemented method of claim 3, wherein the interactive dashboard includes a selection panel including:
a selection to adjust an importance factor for a consideration of risk, a consideration of the carbon footprint, and a consideration of cost; and
a selection to add an alternative supplier.

7. The computer-implemented method of claim 6, wherein the dynamically refining refines which of the plurality of supply chain operations are used within the supply chain network based according to the selection from the selection panel.

8. The computer-implemented method of claim 1, further comprising auto-discovering a set of initial versions of resiliency plans at each stage in the supply chain network, the initial versions of the resiliency plans including the existing supply chain plan,
wherein each resiliency plan has an estimated cost associated with a corresponding resiliency plan.

9. The computer-implemented method of claim 1, further comprising generating a visually explainable clue for the alternative resilience plan.

10. The computer-implemented method of claim 2, wherein the interactive dashboard of the GUI includes parameters that are configurable to modify the alternative resilience plans.

11. The computer-implemented method of claim 10, wherein the parameters include:
a time frame
an alternative supplier on/off;
a climate risk level preference;
a carbon footprint sensitivity; and
a cost sensitivity.

12. (canceled)

13. The computer-implemented method of claim 1, embodied in a cloud-computing environment.

14. A computer program product, the computer program product comprising a computer-readable storage medium having program instructions embodied therewith, the program instructions executable by a computer to cause the computer to perform:
predicting a risk of a plurality of supply chain operations that are used in a supply chain network caused by a term impact analysis of a global hazard;
estimating a carbon footprint for the supply chain network caused by transporting a product between the plurality of the supply chain operations in the supply chain network;
generating an alternative resilience plan as an alternative to an existing supply chain plan based on the predicted risk and the estimated carbon footprint in order to achieve an objective by varying which of the plurality of supply chain operations are used within the supply chain network;
representing the generated alternative resilience plan via an interactive dashboard of a Graphical User Interface (GUI); and
learning a continuous improvement in an auto-discovered resiliency plan as the existing supply chain plan by learning a reward function while training deep reinforcement learning models and solving multi-objective optimization that captures an overall cost, a carbon footprint, a climatic risk, and dynamic user interactions with the GUI,
wherein the generating obtains the objective by creating a simulation environment from which an agent learns a most effective resilience plan for the supply chain network that captures a most cost-effective intervention strategies in a context of the climate risk, the overall cost, and the carbon footprint.

15. The computer program product of claim 14, further comprising:
generating a plurality of alternative resilience plans.

16. The computer program product of claim 15, further comprising dynamically refining a supply chain operation used within the supply chain network based on a selection, via the interactive dashboard, of a resilience plan of the generated alternative resilience plans.

17. The computer program product of claim 14, wherein the alternative resilience plan is generated using at least one of:
a trained deep reinforcement learning;
a multi-objective optimization function; and
a Gaussian Process Regression (GPR).

18. The computer program product of claim 15, wherein the interactive dashboard includes a selection panel including:
a selection to adjust an importance factor for a consideration of risk, a consideration of the carbon footprint, and a consideration of cost; and
a selection to add an alternate supplier.

19. A supply chain optimization system, the system comprising:
a processor; and
a memory, the memory storing instructions to cause the processor to perform:
predicting a risk of a plurality of supply chain operations that are used in a supply chain network caused by a term impact analysis of a global hazard;
estimating a carbon footprint for the supply chain network caused by transporting a product between the plurality of the supply chain operations in the supply chain network;
generating an alternative resilience plan as an alternative to an existing supply chain plan based on the predicted risk and the estimated carbon footprint in order to achieve an objective by varying which of the plurality of supply chain operations are used within the supply chain network;
representing the generated alternative resilience plan via an interactive dashboard of a Graphical User Interface (GUI); and
learning a continuous improvement in an auto-discovered resiliency plan as the existing supply chain plan by learning a reward function while training deep reinforcement learning models and solving multi-objective optimization that captures an overall cost, a carbon footprint, a climatic risk, and dynamic user interactions with the GUI,
wherein the generating obtains the objective by creating a simulation environment from which an agent learns a most effective resilience plan for the supply chain network that captures a most cost-effective intervention strategies in a context of the climate risk, the overall cost, and the carbon footprint.

20. The system of claim 19, embodied in a cloud-computing environment.
